(19) United States
(12) Patent Application Publication
(10) Pub. No.: US 2009/0219106 A1
(43) Pub. Date: Sep. 3, 2009

(54) TWO-PORT ISOLATOR

(75) Inventors: Takefumi Terawaki, Tottori-ken (JP); Minoru Nozu, Tottori-ken (JP); Akinori Misawa, Tottori-ken (JP)

Correspondence Address: SUGHRUE MION, PLLC, 2100 PENNSYLVANIA AVENUE, N.W., SUITE 800, WASHINGTON, DC, 20037, US

(73) Assignee: HITACHI METALS, LTD, MINATO-KU, TOKYO (JP)

(21) Appl. No.: 12/090,546

(22) PCT Filed: Oct. 17, 2006
(86) PCT No.: PCT/JP2006/320682

§ 371 Date: Mar. 26, 2009

(30) Foreign Application Priority Data
Oct. 18, 2005 (JP) 2005-303137

(51) Int. Cl. H01P 1/36

(52) U.S. Cl. 333/24.2

(57) ABSTRACT

A two-port isolator comprising a central conductor assembly comprising first and second central conductors disposed on a ferrite plate, the first central conductor being connected between a first input/output port and a second input/output port, and the second central conductor being connected between a second input/output port and a ground, wherein the first and second central conductors are constituted by two conductor strip patterns formed on both surfaces of an insulating substrate, wherein the conductor strip patterns are crossing at a predetermined angle with insulation, and wherein both end portions of the conductor strip patterns extend from edges of the insulating substrate and are bent to cover side surfaces of the ferrite plate.

### FIELD OF THE INVENTION

The present invention relates to a small, high-precision, two-port isolator used mainly in a microwave band.

### BACKGROUND OF THE INVENTION

Non-reciprocal circuit devices do not substantially attenuate signals in a transmission direction, but largely attenuate signals in an opposite direction. They are used in mobile communications apparatuses such as cell phones, etc. As such non-reciprocal circuit devices, an isolator shown in FIG. 15 is well known. This isolator comprises a ferrite plate 38, three central conductors 31, 32, 33 crossing at an angle of 120° with electric insulation on one main surface of the ferrite plate 38, a ground connected to one end of each central conductor 31, 32, 33, matching capacitors C1-C3 each connected to the other end of each central conductor 31, 32, 33, a terminal resistor Rt connected to a port (for instance, P3) of any one of the central conductors 31, 32, 33, and a permanent magnet (not shown) applying a DC magnetic field Hdc to the ferrite plate 38 in an axial direction. In this isolator, a high-frequency signal input from a port P1 is transmitted to a port P2, but reflecting waves from the port 2 are absorbed by the terminal resistor Rt, so that it is not transmitted to the port P1. Thus, unnecessary reflecting waves are prevented from entering a power amplifier, etc.

Attention has recently been paid to an isolator constituted by a different equivalent circuit from that of the above isolator to have excellent insertion loss characteristics and return loss characteristics (JP 2004-15430 A). This isolator having two central conductors is called “two-port isolator.”

FIGS. 16 and 17 show an equivalent circuit of a two-port isolator, and FIGS. 18 and 19 show its constituting parts. As shown in FIG. 17, this two-port isolator comprises a first input/output port P1, a second input/output port P2, a first central electrode L1 electrically connected between both input/output ports P1, P2, a second central electrode L2 electrically connected between the second input/output port P2 and the ground and crossing the first central electrode L1 with electric insulation, a first matching capacitor Ci and a resistor R electrically connected between the first input/output port P1 and the second input/output port P2 in parallel with the first central electrode L1, and a second matching capacitor Cf electrically connected between the second input/output port P2 and the ground for constituting a parallel resonance circuit with the second central electrode L2.

As shown in FIG. 18, each of the first central conductor L1 and the second central conductor L2 is constituted by two strip line conductors, which are crossing with insulation on a main surface of or inside a ferrite plate 5, to which a DC magnetic field is applied from a permanent magnet 30. As shown in FIG. 19, the first matching capacitor Ci and the second matching capacitor Cf are formed by electrode patterns in the multi-layer ceramic substrate 10, and a main surface of the multi-layer ceramic substrate 10 is provided with connecting pads 15, 17, 18, to which both end portions of the first central conductor L1 and the second central conductor L2 are electrically connected. The connecting pad 17 is connected to a terminal electrode IN (P1) formed on a side surface of the multi-layer ceramic substrate 10 through a via-hole electrode and a side-surface electrode. The connecting pad 18 is connected to the other terminal electrode GND through a via-hole electrode and a side-surface electrode. The electrode pad 15 is connected to a terminal electrode OUT (P2) through a via-hole electrode and a side-surface electrode. The permanent magnet 30, the central conductor assembly 3 and the multi-layer ceramic substrate 10 are contained in a space between an upper case 22 and a lower case 25 both made of a magnetic metal.

Because this two-port isolator having a structure, in which the first central conductor L1 is connected between the first input/output port P1 and the second input/output port P2, has a smaller number of circuit elements than that of a three-port isolator, it has excellent insertion loss characteristics and is suitable for miniaturization.

The size reduction of isolators used in cell phones has been increasingly demanded, as the cell phones have been getting smaller and lighter in weight, and as the number of parts have been increasing due to increase in functions. Although isolators having overall sizes of 3.2 mm×3.2 mm×1.2 mm or 3.2 mm×2.5 mm×1.2 mm are widely used at present, smaller isolators have been finding increasing demand. With such miniaturization, ferrite plates, ceramic multi-layer substrates, central conductors, etc. constituting the two-port isolators should be made smaller.

Central conductors with various shapes, such as copper foils folded around a ferrite plate, those obtained by baking a silver paste printed on ferrite plates, etc., have conventionally been used. However, the copper foils are disadvantageous in the likelihood of breakage, difficulty in folding them around a ferrite plate at a predetermined crossing angle with high precision while securing distance and insulation between them, etc. In the case of printing a silver paste, central conductors should be insulated by insulating materials such as glass, low-temperature-sinterable ceramics, etc. However, because disruption may occur in central conductors due to the shrinkage of the silver paste burned, a combination of the silver paste and an insulator should be optimized. In addition, the number of steps for producing central conductors is larger than when using copper foils.

Connecting pads formed on the multi-layer ceramic substrate should have a small area, but a smaller connecting pad not only makes it difficult to have high-reliability connection to a central conductor, but also makes such connection less reliable against vibration and impact because of a reduced connecting area.

### OBJECT OF THE INVENTION

Accordingly, an object of the present invention is to provide a small two-port isolator, in which central conductors can easily be assembled with high precision, and firmly connected to pads.

### DISCLOSURE OF THE INVENTION

The two-port isolator of the present invention comprises a central conductor assembly comprising first and second central conductors disposed on a ferrite plate, the first central conductor being connected between a first input/output port and a second input/output port, and the second central conductor being connected between a second input/output port and a ground, the first and second central conductors being constituted by two conductor strip patterns formed on both surfaces of an insulating substrate, the conductor strip patterns being crossing at a predetermined angle with insulation, and both end portions of the conductor strip patterns extending from edges of the insulating substrate and being bent to cover side surfaces of the ferrite plate.

The insulating substrate having the conductor strip patterns preferably constitutes an integral flexible circuit board, one surface of the flexible circuit board being provided with an adhesive layer, with which the integral flexible circuit board is attached to the ferrite plate.

The flexible circuit board is preferably formed by attaching metal foils to both surfaces of the insulating substrate to form a composite sheet, and removing the metal foil on each surface of the composite sheet by photolithography to leave a conductor strip pattern having a predetermined shape.

The insulating substrate is preferably large enough to support at least crossing portions of the first and second central conductors, and smaller than a main surface of the ferrite plate on which the flexible circuit board is disposed.

The two-port isolator of the present invention preferably comprises a multi-layer substrate mounting the central conductor assembly, one main surface of the multi-layer substrate being provided with a first pad connected to both one end of the first central conductor and one end of the second central conductor, a second pad connected to the other end of the first central conductor, and a third pad connected to the other end of the second central conductor, the first pad being connected to the second input/output port, the second pad being connected to the first input/output port, and the third pad being connected to the ground.

### BRIEF DESCRIPTION OF THE DRAWINGS

FIG. 1(a) is a plan view showing a flexible circuit board used in the two-port isolator according to one embodiment of the present invention.

FIG. 1(b) is a bottom view showing a flexible circuit board used in the two-port isolator according to one embodiment of the present invention.

FIG. 2 is a cross-sectional view showing a flexible circuit board used in the two-port isolator according to one embodiment of the present invention.

FIG. 3 is a cross-sectional view showing a flexible circuit board used in the two-port isolator according to another embodiment of the present invention.

FIG. 4 is a perspective view showing the two-port isolator according to one embodiment of the present invention.

FIG. 5 is an exploded, perspective view showing the two-port isolator according to one embodiment of the present invention.

FIG. 6 is an exploded, perspective view showing a multi-layer substrate used in the two-port isolator according to one embodiment of the present invention.

FIG. 7(a) is a perspective view showing a front surface of a central conductor assembly used in the two-port isolator according to one embodiment of the present invention.

FIG. 7(b) is a perspective view showing a rear surface of a central conductor assembly used in the two-port isolator according to one embodiment of the present invention.

FIG. 8 is a partially enlarged cross-sectional view showing an end portion of central conductor assembly used in the two-port isolator according to one embodiment of the present invention.

FIG. 9 is a partially enlarged cross-sectional view showing an end portion of a central conductor assembly used in the two-port isolator according to one embodiment of the present invention.

FIG. 10 is a plan view showing a flexible circuit board used in the two-port isolator according to another embodiment of the present invention.

FIG. 11 is a plan view showing a flexible circuit board used in the two-port isolator according to a further embodiment of the present invention.

FIG. 12(a) is a plan view showing a flexible circuit board used in the two-port isolator according to a further embodiment of the present invention.

FIG. 12(b) is a bottom view showing a flexible circuit board used in the two-port isolator according to a further embodiment of the present invention.

FIG. 13 is a plan view showing a lower resin case integrated with external terminals, which is used in the two-port isolator according to one embodiment of the present invention.

FIG. 14 is a partially enlarged cross-sectional view showing a multi-layer substrate and a central conductor assembly mounted in the two-port isolator according to one embodiment of the present invention.

FIG. 15 is a view showing an equivalent circuit of a conventional three-port isolator.

FIG. 16 is a view showing an equivalent circuit of a two-port isolator.

FIG. 17 is a view showing an equivalent circuit of a two-port isolator.

FIG. 18 is an exploded, perspective view showing a conventional two-port isolator.

FIG. 19 is an exploded, perspective view showing a multi-layer substrate used in the conventional two-port isolator.

### DESCRIPTION OF THE PREFERRED EMBODIMENTS

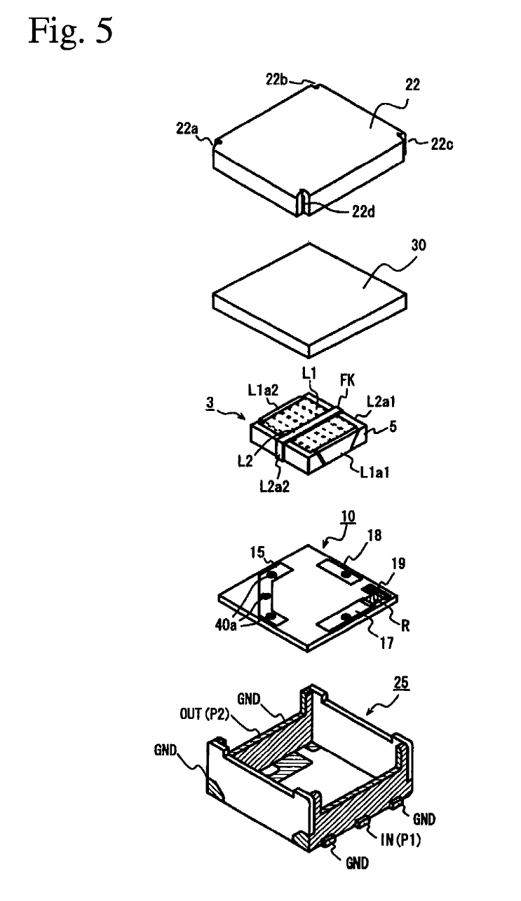

A two-port isolator shown in FIGS. 4 and 5 comprises a central conductor assembly 3 in a rectangular plate shape, which comprises a rectangular ferrite plate 5 and first and second central conductors L1, L2 crossing with electric insulation on the ferrite plate 5, a multi-layer substrate 10 in which first and second matching capacitors are formed, a lower resin case 25 receiving the central conductor assembly 3 and the multi-layer substrate 10 and integrally provided with six external terminals IN (P1), OUT (P2), GND connected to a mother board, which is simply called “external-terminals-integrated lower resin case,” a permanent magnet 30 for applying a DC magnetic field to the ferrite plate 5, and an upper magnetic metal case 22 receiving the permanent magnet 30 for constituting a magnetic circuit. The first and second central conductors L1, L2 are constituted by conductor strip patterns formed on both surfaces of an insulating substrate KB in an integral flexible circuit board FK. The ferrite plate 5 is not restricted to have a rectangular shape but may have a circular or other polygonal shape. Because this two-port isolator has the same equivalent circuit as shown in FIG. 17, its explanation will be omitted.

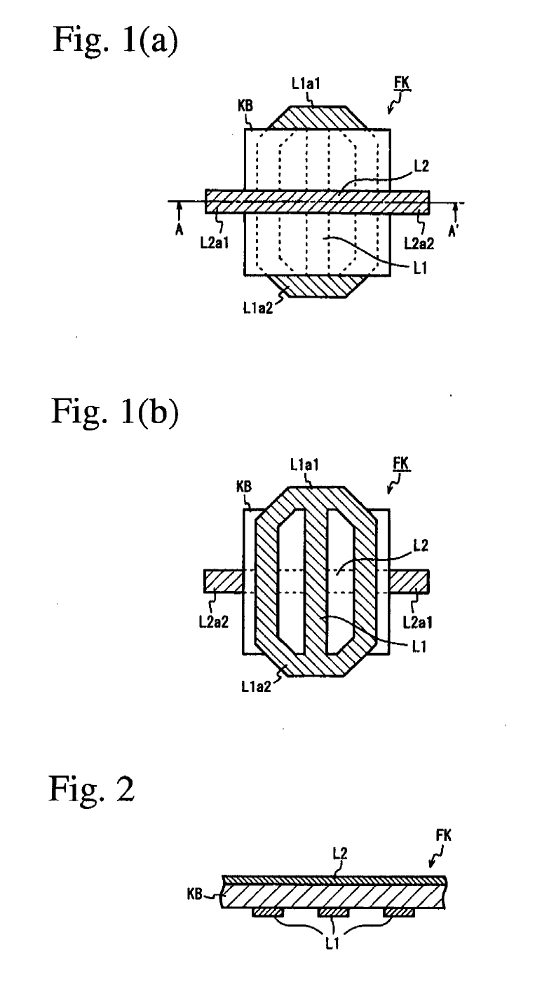

As shown in FIGS. 1 and 2, the first and second central conductors L1, L2 are constituted by conductor strip patterns (for instance, metal foils) crossing at an angle of substantially 90° via an insulating substrate KB on the flexible circuit board FK. The first central conductor L1 is constituted by three parallel metal foils, and end portions L1a1, L1a2 to which the three metal foils are connected. The second central conductor L2 is constituted by one metal foil having end portions L2a1, L2a2. With such a shape, the first central conductor L1 has smaller inductance than that of the second central conductor L2. Each end portion L1a1, L1a2, L2a1, L2a2 slightly extends from the edge of the insulating substrate KB.

Metal foils forming the first and second central conductors L1, L2 (conductor strip patterns) are made of copper, aluminum, silver, etc. Among them, copper is preferable, and electrolytic copper is particularly preferable. An electrolytic copper foil can form a two-port isolator with low loss because of high conductivity, and is resistant to breakage due to plastic deformation because of good bendability.

The conductor strip pattern (metal foil) is preferably as thick as 10-50 μm. When the conductor strip pattern is thinner than 10 μm, it is likely broken when the flexible circuit board FK is bent. A conductor strip pattern thicker than 50 μm provides the flexible circuit board FK with too much thickness and low bendability.

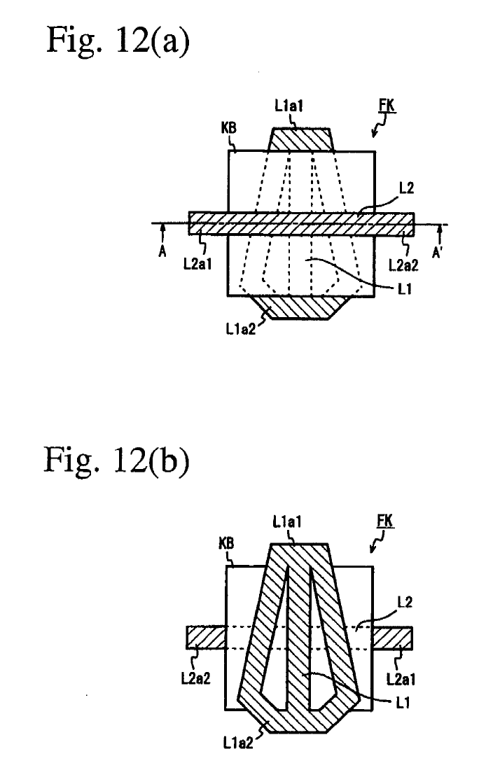

The width and interval of the conductor strip patterns are preferably 100-300 μm, thickness variable depending on the targeted inductance. All intervals between the conductor strip patterns may be the same or partially different. As shown in FIG. 12, for instance, the interval may be narrow on one side and wide on the other side.

The insulating substrate KB is preferably a flexible insulating member such as a resin film, etc. The resin film is preferably made of polyimides such as polyimide, polyetherimide and polyamideimide, polyamides such as nylons, polyesters such as polyethylene terephthalate, etc. Among them, polyamides and polyimides are preferable from the aspect of heat resistance and dielectric loss.

Though not particularly restricted, the insulating substrate KB is preferably as thick as 10-50 μm. When the insulating substrate KB is thinner than 10 μm, it has insufficient bending resistance. When the insulating substrate KB is thicker than 50 μm, there is small coupling between the first and second central conductors L1, L2, and the flexible circuit board is too thick.

The flexible circuit board FK with high precision can be produced by photolithography. Specifically, the conductor strip patterns are formed by coating a photoresist on metal foils attached to both surfaces of the insulating substrate KB, conducting patterning exposure to light, removing a portion of a photoresist layer in which the first and second central conductors L1, L2 are not formed, and removing the metal foils by chemical etching. After removing the remaining photoresist layer, unnecessary portions of the insulating substrate KB are removed by laser or chemical etching (polyimide etching), such that the end portions L1a1, L1a2, L2a1, L2a2 of the first and second central conductors L1, L2 extend from the edge of the insulating substrate KB. Thereafter, a discoloration-preventing treatment and the electric plating of Ni, Au, Ag, etc. are carried out on the conductor strip patterns to improve rust resistance, solderability, electric properties, etc., if necessary.

Because the first and second central conductors L1, L2 are provided with high precision by the flexible circuit board FK, they are free from uneven crossing angles, which give uneven input/output impedance to the two-port isolator.

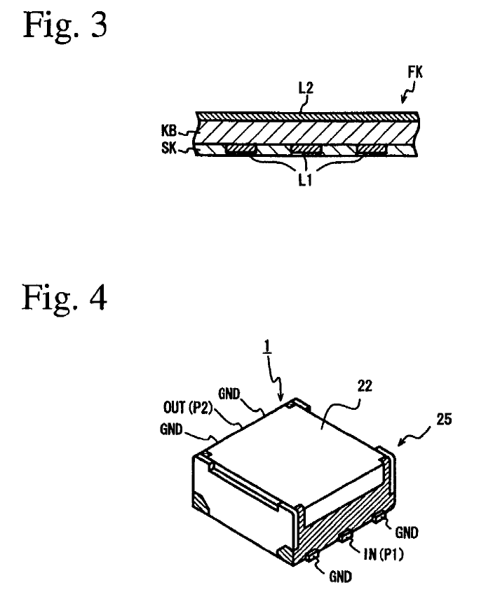

The flexible circuit board FK shown in FIG. 3 comprises an adhesive layer SK in addition to the flexible circuit board FK shown in FIG. 2. The flexible circuit board FK can be bonded to the ferrite plate 5 by the adhesive layer SK. The adhesive layer SK may be made of a thermosetting or thermoplastic resin. The adhesive layer SK can be formed integrally on the flexible circuit board FK, for instance, by overlapping a cover-lay film having the adhesive layer SK to a rear surface of the flexible circuit board FK [shown in FIG. 1(b)] with the adhesive layer SK on the down side, overlapping a cover-lay film having no adhesive layer on the upper surface [shown in FIG. 1(a)], and pressing them at a temperature of about 100-180° C. and pressure of about 1-5 MPa for about 1 hour. The adhesive layer SK is formed on the entire surface of the first central conductor L1, part of the rear surface of the insulating substrate KB, which is not covered with the first central conductor L1, and the entire surfaces of the end portions L2a1, L2a2 of the second central conductor L2. The cover-lay is removed when the flexible circuit board FK is attached to the ferrite plate 5. The adhesive layer SK may also be formed by spraying or printing an adhesive.

The flexible circuit board FK used in a square two-port isolator of 2.5 mm×2.5 mm has such a size that it is contained in a range of, for instance, 2 mm×2 mm when viewed from above. Because it is not practical to produce such a small flexible circuit board FK one by one, pluralities of flexible circuit boards connected with frames are preferably produced at once. Because edge portions of the insulating substrate KB are removed such that the central conductors have projecting end portions, the end portions of the conductor strip patterns are connected to the frames. Accordingly, pluralities of flexible circuit boards FK connected via frames are first formed, and the conductor strip patterns are separated from the frames to produce individual flexible circuit boards FK. Though the numbers of steps are increased, part of the insulating substrates KB may be connected to a frame, and the flexible circuit boards may be separated later.

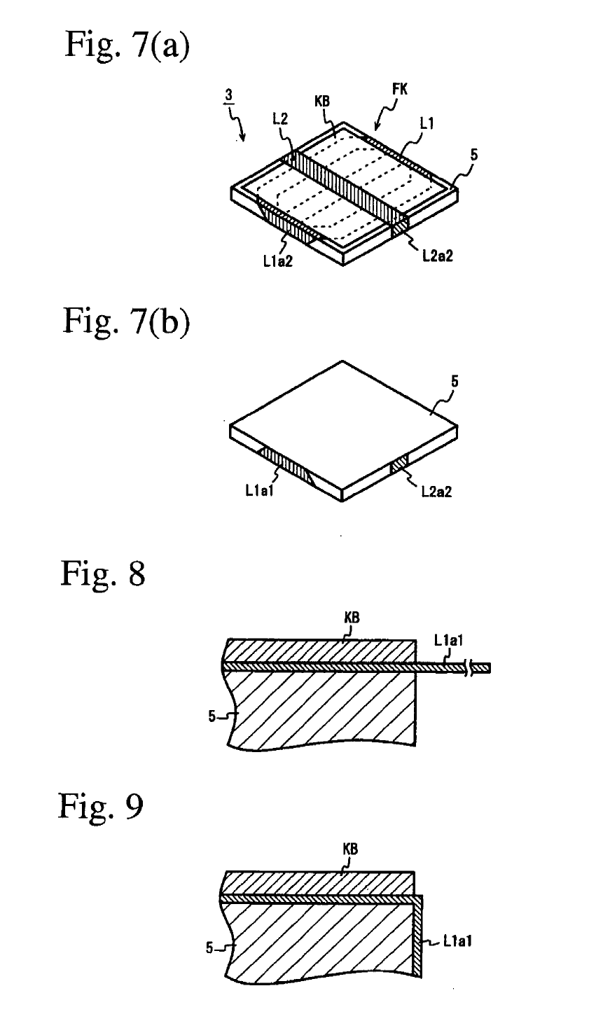

FIGS. 7(a) and 7(b) show the main and rear surfaces of a central conductor assembly 3, and FIGS. 8 and 9 show end portions of the central conductor assembly 3. In this embodiment, a flexible circuit board FK is disposed on a rectangular ferrite plate 5, and the end portions L1a1, L1a2, L2a1, L2a2 of the first and second central conductors L1, L2 are bent along a side surfaces of the ferrite plate 5. Each end portion L1a1, L1a2, L2a1, L2a2 of the bent central conductors L1, L2 has a size not reaching the rear surface of the ferrite plate 5. When the central conductors L1, L2 are formed by copper foils having good bendability, they suffer little spring-back when being bent. When the flexible circuit board FK has an adhesive layer SK, the end portions L1a1, L1a2, L2a1, L2a2 of the central conductors L1, L2 can be adhered to the side surfaces of the ferrite plate 5. When the central conductor is constituted by a thin, conductor strip pattern, its end portion is preferably width enough to secure a soldering area.

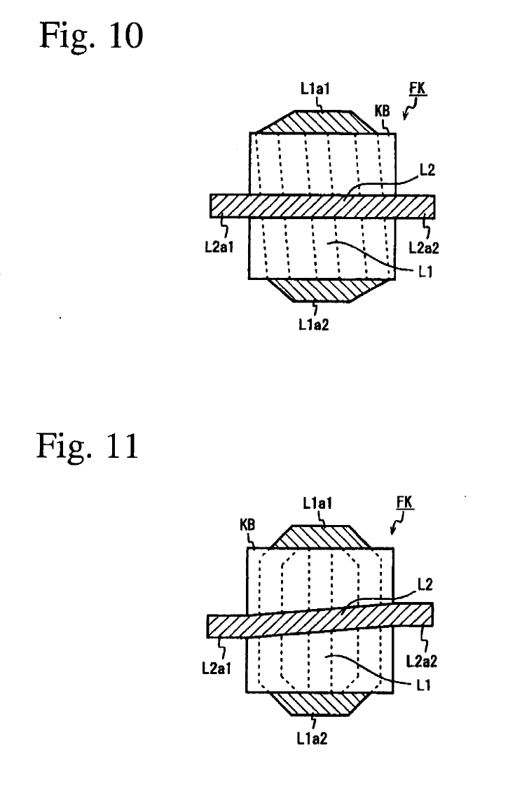

FIGS. 10 and 11 show other examples of flexible circuit boards FK. In these examples, the crossing angle of the first and second central conductors L1, L2 is slightly deviating from 90°. Input/output impedance changes with the crossing angle of the first and second central conductors L1, L2, thereby changing a magnetic field for obtaining the optimum operation of the two-port isolator. Accordingly, the crossing angle of the first and second central conductors L1, L2 is preferably in a range of 80-1100, taking into consideration the magnetic properties and shape of the permanent magnet 30. In this case, too, the first and second central conductors L1, L2 are formed as part of the integral flexible circuit board FK, so that their crossing angle can be easily changed with high precision.

The ferrite plate 5 has a garnet structure, which is made of yttrium-iron-garnet (YIG), etc. In YIG, part of Y may be substituted by Gd, Ca, V, etc., and part of Fe may be substituted by Al, Ga, etc. A Ni-containing ferrite plate may also be used depending on the frequency band.

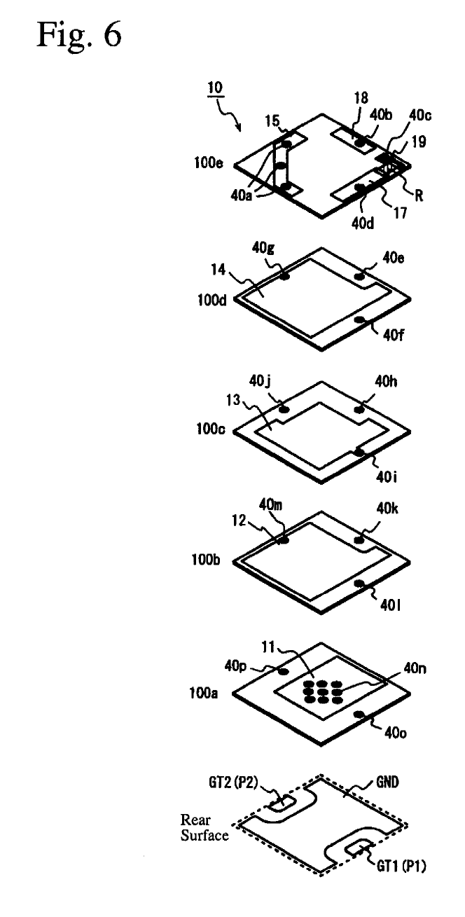

The multi-layer substrate 10 is, for instance, a ceramic laminate shown in FIG. 6. The ceramic laminate may be formed by forming ceramic green sheets 100a-100e having a predetermined thickness from dielectric ceramics and a binder by a doctor blade method, etc., printing electrode patterns 11-14 for matching capacitors and ground electrode patterns GND on the ceramic green sheets, laminating and bonding them under pressure, and sintering the resultant laminate.

The dielectric ceramics are preferably low-temperature-sinterable, dielectric ceramic compositions, which may be (a) a composition comprising Al₂O₃, SiO₂ and SrO as main components, and CaO, PbO, Na₂O and K₂O as sub-components, (b) a composition comprising Al₂O₃ as a main component, and MgO, SiO₂ and GdO as sub-components, and (c) a composition comprising Al₂O₃, SiO₂, SrO and Ti as main components, and Bi₂O₃ as a sub-component, etc.

The number of lamination in the multi-layer substrate 10 may be properly changed depending on the capacitance of the first and second matching capacitors Ci, Cf. Electrode patterns for the matching capacitors are connected through via-hole electrodes (shown by black circles in the figure).

As shown in FIG. 6, a first terminal GT1, a second terminal GT2 and a ground electrode GND formed on the rear surface of the multi-layer substrate 10 are connected by soldering to terminals (for instance, first and second terminals TT1, TT2 described later) formed on a lower resin case 25 integrally provided with external terminals, to achieve electric connection with external terminals (IN, OUT, GND). Printed on an upper surface of the multi-layer substrate 10 are a first pad 15 connected to end portions (common electrodes) L1a2, L2a2 of the first and second central conductors L1, L2, and second and third pads 17, 18 connected to the other end portions L1a1, L2a1 of the first and second central conductors L1, L2.

The multi-layer substrate 10 in this embodiment comprises five ceramic green sheets 100a-100e. The green sheets 100a-100e are printed with a conductive paste to form electrode patterns. The electrode patterns on the layers are electrically connected through via-hole electrodes 40a-40p formed by filling through-holes in each layer with a conductive paste, so that they are properly connected to the ground electrode GND and the first and second terminals GT1, GT2 formed on the rear surface of the multi-layer substrate 10.

The lowermost ceramic green sheet 100a has via-hole electrodes 40n, 40o, 40p, and an electrode pattern 11, which is connected to the ground electrode pattern GND on the rear surface through pluralities of via-hole electrodes 40n. The ceramic green sheet 100b has via-hole electrodes 40k, 40l, 40m, and an electrode pattern 12 constituting the second matching capacitor Cf. The ceramic green sheet 100c has via-hole electrodes 40h, 40i, 40j, and an electrode pattern 13, and the ceramic green sheet 100d thereon has via-hole electrodes 40e, 40f, 40g and an electrode pattern 14. The electrode pattern 12 connected to the electrode pattern 14 through via-hole electrodes 40g, 40j constitutes the first matching capacitor Ci with the electrode pattern 13. The uppermost ceramic green sheet 100e has via-hole electrodes 40a, 40b, 40c, 40d, first to third pads 15, 17, 18, a connecting portion 19, and a resistor R.

In this embodiment, at least part of hot-side electrode patterns for the first and second matching capacitors Ci, Cf are formed by common electrode patterns, thereby reducing the number of electrode patterns. Because the common electrode patterns are connected to the above common electrodes through via-hole electrodes formed in the multi-layer substrate, the first central conductor L1 and the first matching capacitor Ci are connected by a short conductor, and the second central conductor L2 and the second matching capacitor Cf are connected by a short conductor. As a result, resonance current path becomes shorter, reducing loss by the connecting conductors.

The resistor R can be formed by printing a conductive paste containing ruthenium, etc. The resistor R may be printed on a layer in the multi-layer substrate 10, or a chip resistor may be mounted on the multi-layer substrate 10. Electrode patterns appearing on the multi-layer substrate 10 are preferably plated to have enough heat resistance to withstand soldering. The plating preferably comprises a lower layer of Ni or Ni—P plating, and an upper layer of solder or Au plating.

As shown in FIG. 14, the central conductor assembly 3 is disposed on the multi-layer substrate 10, such that an end portion L1a1 of the first central conductor L1 in the central conductor assembly 3 is positioned on the second pad 17 of the multi-layer substrate 10, and the end portion L1a1 is connected to the second pad 17 with solder Sd using a method such as reflow, etc. With all pads 15, 17, 18 connected by such method, the end portions L1a1, L1a2, L2a1, L2a2 of the first and second central conductors L1, L2 provided on the side surfaces of the central conductor assembly 3 are firmly connected to the first to third pads 15, 17, 18.

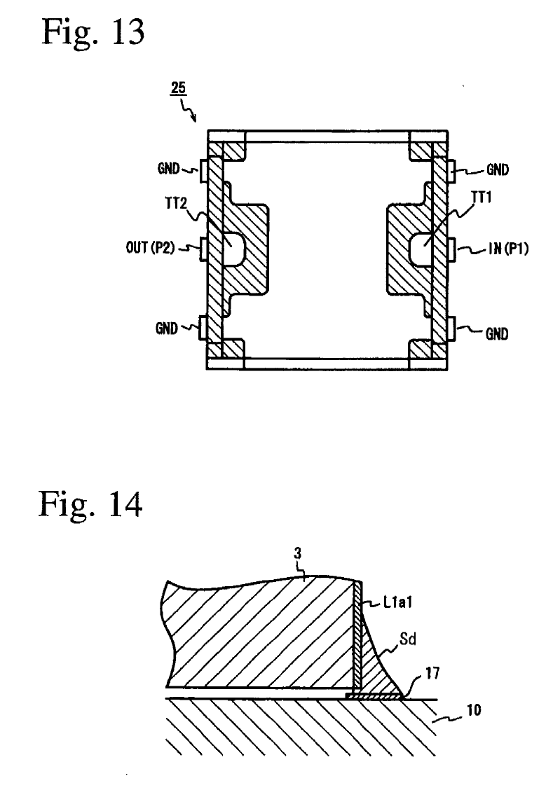

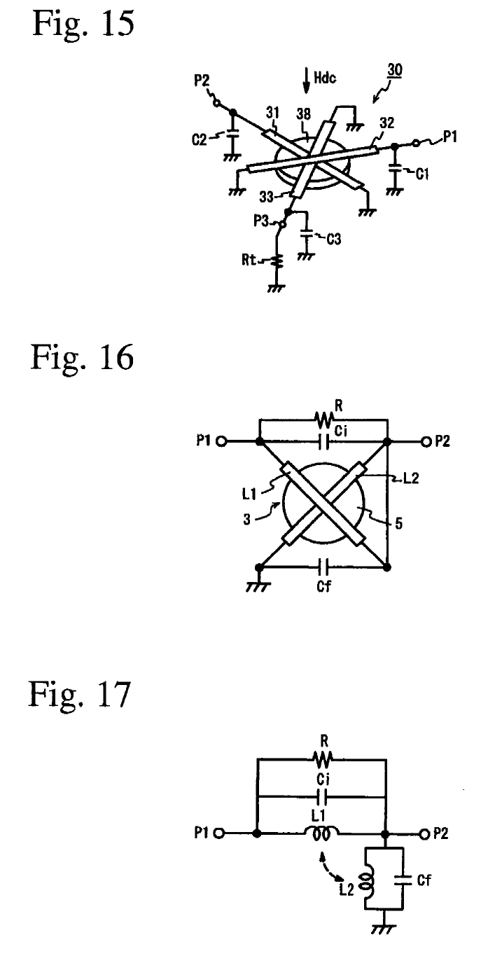

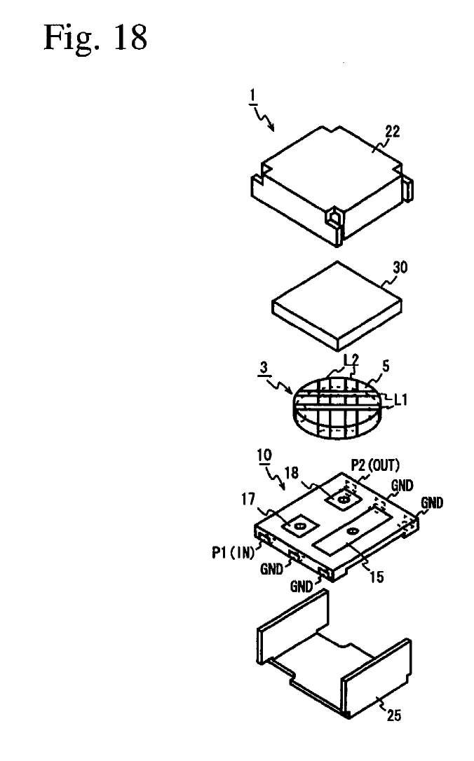

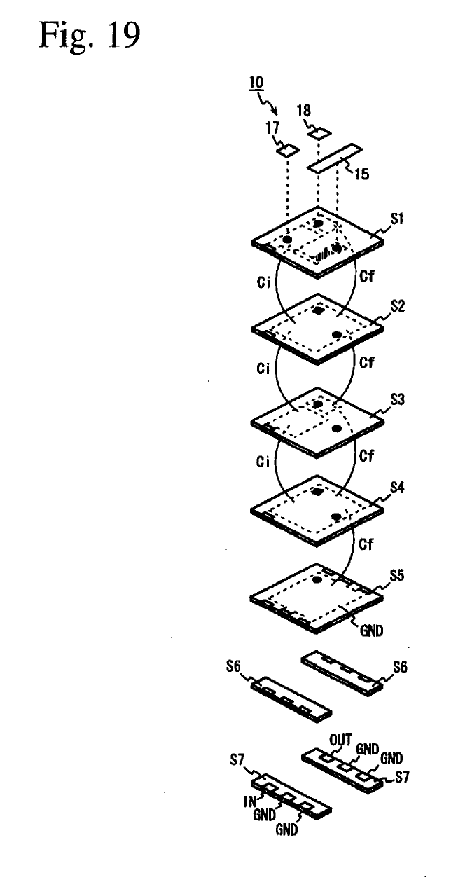

As shown in FIG. 13, the lower resin case 25 provided with six external terminals IN (P1), OUT (P2) and GND acts as a container for parts and a magnetic yoke. The lower case 25 comprises a magnetic metal portion (forming a lower yoke) constituting a bottom portion and two sidewalls integrally rising therefrom, and a resin portion (shown by hatching in the figure) constituting the other two sidewalls having six external terminals. The magnetic metal portion is preferably formed by a cold-rolled steel plate (SPCC), a 42-alloy (Ni₄₂-Fe_{bal} alloy), an Fe—Co alloy, etc. The 42-alloy has excellent oxidation resistance. The resin portion is preferably formed by high-heat-resistance, thermoplastic, engineering plastics such as liquid crystal polymers, polyphenylene sulfide, etc.

The magnetic metal portion and the resin portion in the lower case 25 are integrally formed by an insert-molding method, etc. For instance, a magnetic metal sheet is punched out to such a shape that a lower yoke and the external terminals IN (P1) and OUT (P2) are connected to a frame, and the lower yoke is bent. With an integral body of the lower yoke, the external terminals and the frame placed in a die, a thermoplastic resin is insert-molded, and the frame is finally cut off. Part of the lower yoke is used as external terminals GND. In this embodiment, the lower yoke and four external terminals GND are integrally formed by punching one metal plate, but the external terminals IN (P1) and OUT (P2) may be formed by separate metal sheets.

The lower yoke and the first and second terminals TT1, TT2 are exposed on the flat, inner bottom surface of the lower resin case 25 integral with external terminals. The multi-layer substrate 10 is disposed on the inner bottom surface of the lower case 25, and the ground electrode GND formed on the rear surface of the multi-layer substrate 10 is connected to the inner bottom surface of the lower yoke by soldering. The first and second terminals GT1, GT2 of the multi-layer substrate 10 are connected to the first and second terminals TT1, TT2 of the lower case 25 by soldering.

The magnetic metal sheet is a cold- or hot-rolled, thin plate of about 70-300 μm, which is coated with a high-conductivity metal having electric resistivity of 5.5 μΩ·cm or less, preferably 3.0 μΩ·cm, more preferably 1.8 μΩ·cm or less. The high-conductivity metal coating has a thickness of 0.5-25 μm, preferably 0.5-10 μm, more preferably 1-8 μm.

The high-conductivity metal coating is made of silver, copper, gold, aluminum or their alloys. The high-conductivity metal coating acts as a path of high-frequency current to the ground terminals, increasing the transmission efficiency of high-frequency signals, and reducing loss by suppressing interference with external circuits.

The upper case 22 constituting a magnetic circuit with the lower yoke is preferably formed by a magnetic metal like the lower yoke. Their magnetic metals may be the same or different. The upper case 22 is preferably coated with a high-conductivity metal like the lower yoke.

The permanent magnet 30 contained in the upper case 22 is preferably a ferrite magnet (basic composition: SrO—nFe₂O₃) from the aspect of cost and matching with the ferrite plate 5. Particularly preferable is a ferrite magnet having a magnetoplumbite crystal structure, in which part of Sr and/or Ba are substituted by an R element (at least one of rare earth elements including Y), and part of Fe is substituted by an M element (at least one selected from the group consisting of Co, Mn, Ni and Zn). This ferrite magnet has a high magnetic flux density, making the two-port isolator small and thin.

Notches 22a-22d provided at four corners of the upper case 22 receive resin pillars at four corners of the lower case 25, such that the upper case 22 is precisely mated with the lower case 25. It is preferable that one sidewall of the lower yoke is fixed to one sidewall of the upper case 22 by solder or adhesive, while the other sidewall of the lower yoke is fixed to the other sidewall of the upper case 22 by adhesive. With the upper and lower yokes thus electrically insulated, current flowing in the central conductors does not induce current flow in the upper case 22, thereby preventing the deterioration of the insertion loss characteristics of the two-port isolator.

The two-port isolator according to a preferred embodiment of the present invention has an overall size of 2.5 mm×2.5 mm×1.2 mm, comprises the ferrite plate 5 having an overall size of 1.3 mm×1.3 mm×0.2 mm, and is adapted to a frequency of 1920-1980 MHz. Evaluation revealed that this two-port isolator has comparable insertion loss at a frequency of 1920-1980 MHz, to that of a square two-port isolator of 3.2 mm×3.2 mm, in which copper foils as central conductors are wound around a ferrite plate.

A board to which this two-port isolator is soldered is screwed to a die-cast aluminum jig, and subjected to free fall from a height of 1.8 mm to a concrete 100 times. The observation of the connection of the central conductor assembly 3 to the multi-layer substrate 10 by a magnifying lens after the free fall test revealed that no peeling occurred between the end portions L1a1, L1a2, L2a1, L2a2 of the first and second central conductors L1, L2 and the first to third pads 15, 17, 18 of the multi-layer substrate 10. A conduction test using a milliohmmeter revealed that DC resistance did not increase between the second pad 17 of the multi-layer substrate 10 and the terminal electrode GND of the lower resin case 25 integral with external terminals.

Although the present invention has been explained above referring to the attached drawings, the present invention is not restricted thereto, and various modifications can be made. For instance, the shapes of the first and second central conductors L1, L2 are not restricted to those depicted, but may be properly changed depending on the targeted inductance within the scope of the present invention.

### EFFECT OF THE INVENTION

Because the two-port isolator of the present invention comprises first and second central conductors constituted by two conductor strip patterns, which are formed on both surfaces of an insulating substrate such that they are crossing at a predetermined angle with insulation, both end portions of each conductor strip pattern extending from the edge of the insulating substrate, a central conductor assembly can be easily and firmly assembled by fixing the first and second central conductors to a ferrite plate, and bending their both end portions to side surfaces of the ferrite plate. In addition, because the first and second central conductors are free from unevenness in a crossing angle and variations when assembled, the two-port isolator can easily be assembled with high precision.

1. A two-port isolator comprising a central conductor assembly comprising first and second central conductors disposed on a ferrite plate, said first central conductor being connected between a first input/output port and a second input/output port, and said second central conductor being connected between a second input/output port and a ground, wherein said first and second central conductors are constituted by two conductor strip patterns formed on both surfaces of an insulating substrate, wherein said conductor strip patterns are crossing at a predetermined angle with insulation, and wherein both end portions of said conductor strip patterns extend from edges of said insulating substrate and are bent to cover side surfaces of said ferrite plate.

2. The two-port isolator according to claim 1, wherein the insulating substrate having said conductor strip patterns constitutes an integral flexible circuit board, and wherein one surface of said flexible circuit board is provided with an adhesive layer, with which said integral flexible circuit board is attached to said ferrite plate.

3. The two-port isolator according to claim 2, wherein said flexible circuit board is formed by attaching metal foils to both surfaces of the insulating substrate to form a composite sheet, and removing said metal foil on each surface of the composite sheet by photolithography to leave a conductor strip pattern having a predetermined shape.

4. The two-port isolator according to claim 1, wherein said insulating substrate is large enough to support at least crossing portions of said first and second central conductors, and smaller than a main surface of said ferrite plate on which said flexible circuit board is disposed.

5. The two-port isolator according to claim 1, which comprises a multi-layer substrate mounting said central conductor assembly, one main surface of said multi-layer substrate being provided with a first pad connected to both one end of said first central conductor and one end of said second central conductor, a second pad connected to the other end of said first central conductor, and a third pad connected to the other end of said second central conductor, said first pad being connected to said second input/output port, said second pad being connected to said first input/output port, and said third pad being connected to the ground.
